(19) United States
(12) Patent Application Publication
(10) Pub. No.: US 2017/0096729 A1
(43) Pub. Date: Apr. 6, 2017

(54) ELECTRICAL WIRE OR CABLE, WIRE HARNESS, AND METHOD OF MANUFACTURING ALUMINUM ALLOY STRAND

(71) Applicant: YAZAKI CORPORATION, Tokyo (JP)

(72) Inventors: Moriatsu TANIGUCHI, Shizuoka (JP); Naonari UCHIDA, Shizuoka (JP)

(73) Assignee: YAZAKI CORPORATION, Tokyo (JP)

(21) Appl. No.: 15/381,246

(22) Filed: Dec. 16, 2016

Related U.S. Application Data
(63) Continuation of application No. PCT/JP2015/069172, filed on Jul. 2, 2015.

(30) Foreign Application Priority Data
Jul. 3, 2014 (JP) 2014-137543

(51) Int. Cl. C22F 1/04; B21C 1/02; H01B 13/00; H01B 7/00; H01B 1/02; B21C 1/00; C22C 21/00

(52) U.S. Cl. CPC C22F 1/04; B21C 1/003; B21C 1/02; C22C 21/00; H01B 7/0045; H01B 1/023; H01B 13/0016

(57) ABSTRACT

A method of manufacturing an aluminum alloy strand from an aluminum alloy containing: not less than 0.001 mass % and less than 0.009 mass % of Ti, 0.4 to 0.9 mass % of Fe, 0.005 to 0.008 mass % of Zr, 0 to 0.02 mass % of Si, and at least one of 0 to 0.05 mass % of Cu and 0.04 to 0.45 mass % of mg with a residue being composed of aluminum and inevitable impurities, the method comprising the steps of:
(1) a step of forming a wire rod using the aluminum alloy;
(2) a step of drawing the wire rod to a desired final diameter without performing heat treatment; and
(3) a step of continuous annealing or batch annealing the drawn wire material.

### CROSS REFERENCE TO RELATED APPLICATION

This application is a Continuation of PCT Application No. PCT/JP2015/069172, filed on Jul. 2, 2015, and claims the priority of Japanese Patent Application No. 2014-137543, filed on Jul. 3, 2014, the content of all of which is incorporated herein by reference.

### BACKGROUND

1. Technical Field

The present invention relates to an electrical wire or cable including an aluminum alloy strand, a wire harness, and a method of manufacturing an aluminum alloy strand.

2. Related Art

The conductor material of electrical wires (that is, conductors) used in wire harnesses for automobiles have been primarily copper. In recent years, aluminum is attracting attentions as the conductor material based on the requirements for weight reduction of conductors. Copper is excellent in terms of tensile strength and conductivity as the material but has a problem of large weight. (that is, high density). On the other hand, aluminum is lightweight but provides insufficient strength.

As an aluminum alloy material for conductors, Patent Literature 1 discloses an aluminum alloy wiring material in which iron (Fe), zirconium (Zr), and other elements are blended in a matrix made of highly-pure aluminum with a purity of not less than 99.95%. Patent Literature 2 discloses an aluminum alloy wiring material in which copper (Cu) and/or magnesium (Mg) and Zr and/or silicon (Si) are contained in a matrix made of highly-pure aluminum with a purity of not less than 99.95%. Patent Literatures 3 and 4 disclose aluminum alloy wiring materials each including predetermined amounts of Fe, Mg, and Si. Patent Literature 5 discloses an aluminum alloy wiring material including a predetermined amount of titanium (Ti) and the like.

Patent Literature 1: Japanese Unexamined Patent Application Publication No. 2011-171291

Patent Literature 2: Japanese Unexamined Patent Application Publication No. 2006-176832

Patent Literature 3: Japanese Unexamined Patent. Application. Publication No. 2006-19163

Patent Literature 4: Japanese Unexamined Patent Application Publication No, 2004-134212

Patent Literature 5: Japanese Unexamined Patent Application Publication No. 2003-13162

### SUMMARY

Typical strands serving as conductors are manufactured by casting and rolling an alloy material into a wire rod and then repeating heat treatment (that is, annealing) and wire drawing for the wire rod.

Each of the aluminum alloys described in Patent Literatures 1 to 4, for example, can be thinned to a desired thickness with disconnection being prevented by heat treatment performed between wire drawing processes. However, it is not preferable in terms of time and cost to perform plural heat treatment processes in a batch manner or the like.

On the other hand, continuous wire drawing is performed after heat treatment in Patent. Literature 5. However, when heat treatment is performed before wire drawing, the resultant wire is more likely to be hardened due to hardening by the wire drawing subsequent to heat treatment and will have low conductivity and low elongation properties. Moreover, the predetermined amount of Ti contained in the aluminum alloy wiring material described in Patent Literature 5 could considerably reduce the conductivity of the electrical wire.

If a copper strand constituting a conductor of an electrical wire is replaced with an aluminum alloy strand which is made of the conventional aluminum alloy described in Patent Literatures 1 to 5 and the like and has the same thickness as the copper strand, the mass of the electrical wire is reduced to about one-third. The aluminum alloy electrical wire has a higher conductor resistance than the copper electrical wire and is difficult to implement matching (fuse matching) between smoke-emission characteristics of the electrical wire depending on insulator deterioration and the fuse blow characteristics. Accordingly, to actually replace a copper electrical wire with an aluminum alloy electrical wire, it is necessary to increase the gauge of the aluminum alloy electrical wire by one or two sizes in the light of fuse matching and conductor resistance. As an example of replacing an electrical wire with an electrical wire having one or two sizes larger, a 0.5 Sq copper electrical wire is replaced with a 0.75 to 1 Sq aluminum alloy electrical wire. In the case of replacing a copper electrical wire with a conventional aluminum alloy electrical wire, therefore, the aluminum alloy electrical wire is thicker than the copper electrical wire. Accordingly, aluminum alloy strands used in an aluminum alloy electrical wire are required to have low conductor resistance, that is, high conductivity. To be specific, current aluminum alloy strands are required to have conductivities of not lower than 58% IACS. Moreover, aluminum alloy strands are desired to have tensile strengths of not lower than 120 MPa from the viewpoint of workability. Aluminum alloy strands are thus required to have both conductivities of not lower than 58% IACS and tensile strengths of not lower than 120 MPa.

An object of the present invention is to provide an electrical wire or cable including an aluminum alloy strand which includes conductivity and tensile strength enough as a wiring material and is excellent in drawing workability, a wire harness including the aluminum alloy strand, and a method of manufacturing the aluminum alloy strand.

A method of manufacturing an aluminum alloy strand according to a first aspect of the present invention is a method of manufacturing an aluminum alloy strand from an aluminum alloy containing: not less than 0.001 mass % and less than 0.009 mass % of Ti, 0.4 to 0.9 mass % of Fe, 0.005 to 0.008 mass % of Zr, 0 to 0.02 mass % of Si, and at least one of 0 to 0.05 mass % of Cu and 0.04 to 0.45 mass % of Mg with a residue being composed of aluminum and inevitable impurities, the method, including the following steps:
(1) a step of forming a wire rod using the aluminum alloy;
(2) a step of drawing the wire rod to a desired final diameter without performing heat treatment; and
(3) a step of continuous annealing or batch annealing the drawn wire material.

The method of manufacturing an aluminum alloy strand according to a second aspect of the present invention is the method of manufacturing an aluminum alloy strand, wherein the disconnection rate during the process of manufacturing the aluminum alloy strand starting with an aluminum alloy rod through a drawing step and the like is 25000 m per disconnection or more. An electrical wire or cable of the present invention is preferably the electrical wire or cable obtained by the method of manufacturing an aluminum alloy strand according to a first aspect of the present invention, wherein the aluminum alloy strand has a conductivity of not less than 58% IACS and a tensile strength of not less than 120 MPa.

A wire harness of the present invention preferably includes the above-described electrical wire or cable.

### DETAILED DESCRIPTION

Aluminum alloy used as a material of an aluminum alloy strand according to an embodiment and as a raw material thereof includes an aluminum ingot as a matrix and predetermined elements added thereto.

The aluminum ingot is preferably pure aluminum with a purity of not less than 99.7 mass %. Among pure aluminum ingots prescribed in JIS H 2102, the aluminum ingot of the embodiment can be one of ingots having the same purities as Grade-1 aluminum ingots or higher. Specifically, the aluminum ingot of the embodiment can be selected from Grade-1 aluminum ingots having purities of 99.7 mass %, Special grade-2 aluminum ingots having purities of not less than 99.85 mass % and Special grade-1 aluminum ingots having purities of not less than 99.90 mass %. In this embodiment, the aluminum ingot can be an affordable aluminum ingot having a purity of 99.7 mass % as well as an expensive and highly pure aluminum ingot like Special grade-1 and Special grade-2 aluminum ingots.

The elements added to the matrix composed of the pure aluminum ingot (that is the aluminum. Raw material) include titanium (Ti), iron (Fe), zirconium (Zr), silicon (Si), and copper (Cu) and/or magnesium (Mg).

Ti is an element which miniaturizes crystal grains of the aluminum alloy and thereby increases the strength and elongation to improve the workability while preventing reduction in conductivity of the aluminum alloy. Ti therefore reduces disconnections during manufacture of the aluminum alloy strand. To obtain this effect, the Ti content of the aluminum alloy as a material of the aluminum alloy strand is not less than 0.001 mass % and less than 0.009 mass % and is preferably 0.003 to 0.007 mass %. In this specification, the description “a to b mass %” means “not less than a mass % and not more than b mass %”. Moreover, the Ti content of the aluminum alloy as a raw material of thel aluminum alloy strand is preferably within the same numerical range as that of the Ti content of the material of the finished aluminum alloy strand.

The workability of the aluminum alloy improves as the strength and elongation of the aluminum alloy increase. Such an improvement in workability of the aluminum alloy reduces disconnections of aluminum alloy strands during manufacture. The frequency of occurrence of disconnections can be evaluated using a disconnection rate. Herein, the disconnection rate refers to length of aluminum alloy strand per one disconnection during the process of manufacturing the aluminum alloy strand starting with an aluminum alloy rod through a drawing step, a twisting step, a compression step, and the like. When the aluminum alloy rod is disconnected twice during manufacture of a 50000 m aluminum alloy strand, the disconnection rate is 50000 m/twice, that is, 25000 m per disconnection. The higher the disconnection rate, the lower the frequency of occurrence of disconnections during manufacture.

The aluminum alloy strand of the embodiment has a low frequency of occurrence of disconnections. This eliminates the need to peel the surface layer of the aluminum alloy wire material before wire drawing, that is, a so-called peeling process. The peeling process is a process to remove the surface layer of an aluminum alloy wire material before wire drawing so that damages in the surface layer will not remain in the aluminum alloy strand as the final product. Since the aluminum alloy used in the embodiment has high workability, the aluminum alloy strand disconnects at lower frequency during manufacture without being subjected to the so-called peeling process.

In the aluminum alloy, Fe is an element which has a low limit of solid solubility and brings out a strengthening mechanism to increase the strength mainly through precipitation strengthening. Fe is therefore capable of increasing the strength of the aluminum alloy without reducing the conductivity. To obtain the above effects, the Fe content of the aluminum alloy as the material of the aluminum alloy strand is not less than 0.1 mass % and less than 1.0 mass %. To preferably obtain the above effects, the Fe content of the aluminum alloy is preferably 0.4 to 0.9 mass %. The Fe content of the aluminum alloy as the raw material of the aluminum alloy strand is preferably within the same numerical range as that of the Fe content of the material of the finished aluminum alloy strand.

Zr is an element which is effective on improving the heat resistance of the aluminum alloy and is capable of increasing the strength through solid solution strengthening. To obtain the effect, the Zr content of the aluminum alloy as the material of the aluminum alloy strand is 0 to 0.08 mass %. To preferably obtain the aforementioned effect, the Zr content of the aluminum alloy is preferably 0 to 0.05 mass % and can be practically 0.02 to 0.08 mass %. The Zr content of the aluminum alloy as the raw material of the aluminum alloy strand is preferably within the same numerical range as that of the Zr content of the material of the finished aluminum alloy strand.

Si is an element effective on improving the strength of the aluminum alloy. To obtain the above effect, the Si content of the aluminum alloy as the material of the aluminum alloy strand is preferably 0.02 to 2.8 mass %. To preferably obtain the above effect, the Si content of the aluminum alloy is preferably 0.02 to 1.8 mass % and is more preferably 0.02 to 0.25 mass %. The Si content of the aluminum alloy as the raw material of the aluminum alloy strand is preferably within the same numerical range as that of the Si content of the material of the finished aluminum alloy strand.

Cu and Mg are elements capable of increasing the strength of the aluminum alloy through solid solution strengthening. The aluminum alloy as the material of the aluminum alloy strand of the embodiment contains at least one of Cu and Mg. The Cu content of the aluminum alloy as the material of the aluminum alloy strand is typically 0.05 to 0.63 mass %. To preferably obtain the above effect, the Cu content of the aluminum alloy is 0.2 to 0.5 mass % and can be practically 0.06 to 0.49 mass %. The Mg content in the aluminum alloy as the material of the aluminum alloy strand is typically 0.03 to 0.45 mass %. To preferably obtain the above effect, the Mg content of the aluminum alloy is 0.04 to 0.45 mass % and is more preferably 0.15 to 0.3 mass %. The Mg content can be practically 0.03 to 0.36 mass %. When Cu and Mg are both contained in the aluminum alloy, the total content of Cu and Mg in the aluminum alloy is preferably 0.04 to 0.6 mass % and is more preferably 0.1 to 0.4 mass %. The contents of. Cu and Mg in the aluminum alloy as the raw materials of: the aluminum alloy strand are preferably within the same numerical ranges as those of the contents of Cu and Mg of the material of the finished aluminum alloy strand, respectively.

The aforementioned content of each element includes amounts of Si, Fe, Cu, and Mg contained in the aluminum ingot as the matrix of the raw material. The term “content” of each element does not always refer to the additive amount.

It is not preferable for the elements to exceed the aforementioned ranges because the conductivity of the aluminum alloy will be reduced. Specifically, to achieve a conductivity of 58% IACS, which is necessary as automobile electrical wire, the Zr content of the aluminum alloy as the material of the aluminum alloy strand is not more than 0.08 mass %; the Si content of the aluminum alloy is not more than 2.8 mass %; the Cu content of the aluminum alloy is not more than 0.63 mass %; and the Mg content of the aluminum alloy is not more than 0.45 mass %.

A residue of the aluminum alloy used in the embodiment other than above-described Ti, Fe, Zr, Si, Cu, Mg, and the like includes aluminum and inevitable impurities. The inevitable impurities which can be contained in the aluminum alloy are zinc (In), nickel (Ni), manganese (Mn), rubidium (Pb), chrome (Cr), titanium (Ti), tin (Sn), vanadium (V), gallium (Ga), boron (B), sodium (Na), and the like. These impurities are inevitably contained without prohibiting the effects of the embodiment and giving any special influence on the characteristics of the aluminum alloy of the embodiment. The elements previously contained in the pure aluminum ingot for use are also included in the term “inevitable impurities” here.

The content of the inevitable impurities in the aluminum alloy as the material of the aluminum alloy strand is preferably not more than 0.07% in total and is more preferably not more than 0.05%.

The aluminum alloy can be casted according to an ordinary manufacturing process by adding predetermined elements to the aluminum ingot.

The electrical wire or cable according to the embodiment includes a strand consisting of the above-described aluminum alloy as a conductor. Herein, inclusion of an aluminum alloy strand also means inclusion of a stranded wire (that is, a stranded conductor) which is composed of plural strands (3 to 1500 strands; 11 strands, for example) twisted together. Herein, each strand is composed of a solid wire (that is, a solid conductor). The electrical wire or cable according to the embodiment generally includes strands in the form of stranded wire (also referred to as a core).

In the electrical wire or cable according to the embodiment, the configuration and number of aluminum alloy strands included in the electrical wire are not particularly limited. For example, the electrical wire can employ a two-layer structure in which an aluminum alloy strand assembly (hereinafter, referred to as a first strand section) composed of one or plural aluminum alloy strands twisted at the center; and a layer (hereinafter, referred to as a second strand section) of plural aluminum alloy strands twisted on the outer circumference of the first strand section. The electrical wire can employ a three-layer structure in which a layer (hereinafter, referred to as a third strand section) of plural twisted aluminum strands is formed outside of the second strand section of the two-layer structure electrical wire.

Concrete examples of the aluminum alloy electrical wire of the two-layer structure include: an electrical wire in which the first strand section is composed of one aluminum alloy strand and the second strand section is composed of six aluminum alloy strands (hereinafter, referred to as a “1-6 type electrical wire”); an electrical wire in which the first strand section is composed of three aluminum alloy strands and the second strand section is composed of eight aluminum alloy strands (hereinafter, referred to as a “3-8 type electrical wire”); and an electrical wire in which the first strand section is composed of six aluminum alloy strands and the second strand section is composed of ten aluminum alloy strands (hereinafter, referred to as a “6-10 type electrical wire”). Concrete examples of the aluminum alloy electrical wire of the three-layer structure include: an electrical wire in which the first strand section is composed of one aluminum alloy strand, the second strand section is composed of six aluminum alloy strands, and the third strand section is composed of twelve aluminum alloy strands (hereinafter, referred to as a “1-6-12 type electrical wire”.

In the electrical wire or cable according to the embodiment, the aluminum alloy strands included in the electrical wire may have cross sections which are deformed due to a compression process at manufacture so that gaps between adjacent aluminum alloy strands are reduced. Herein, the compression process is a process to compress the stranded wire which is composed of plural twisted aluminum alloy strands each having a circular cross section to deform the cross sections of the aluminum alloy strands so that gaps between adjacent aluminum alloy strands are reduced.

The cross section of each deformed aluminum alloy strand has a hexagonal shape, a sector shape, or a C-shape, for example. Herein, the sector shape is a shape obtained by dividing a circle along radii into plural sections. The C-shape is the shape of one of the plural pieces obtained by radially cutting an annulus having width in the radial direction, such as a toroidal shape when such plural aluminum alloy strands having sector-shaped or C-shaped cross sections are twisted, the assembly composed of the plural aluminum alloy strands twisted has a circular or ring-shaped cross section.

Which shape the cross sections of the deformed aluminum alloy strands have: hexagonal shape, sector shape, C-shape, or the like depends on the way the aluminum alloy strands are twisted. In the 1-6 type electrical wire, the aluminum alloy strand of the first strand section has a hexagonal cross section, and each of the six aluminum alloy strands of the second strand section has a C-shaped cross section. In the 3-8 type electrical wire, each of the three aluminum alloy strands of the first strand section has a sector-shaped cross section, and each of the eight aluminum alloy strands of the second strand section has a C-shaped cross section. In the 6-10 type electrical wire, each of the six aluminum alloy strands of the first strand section has a sector-shaped cross section, and each of the ten aluminum alloy strands of the second strand section has a C-shaped cross section. In the 1-6-12 type electrical wire of the three-layer structure, the aluminum alloy strand of the first strand section has a hexagonal cross section, each of the six aluminum alloy strands of the second strand section has a C-shaped cross section, and each of the twelve aluminum alloy strands of the third strand section has a C-shaped cross-section.

The aluminum alloy electrical wire having been subjected to the compression process as described above exerts the following effects. The diameter of the aluminum alloy electrical wire can be reduced for no gap is formed between adjacent aluminum alloy strands constituting the aluminum alloy electrical wire. Moreover, since the assembly of plural twisted aluminum alloy strands has a substantially circular circumference, the layer of resin or the like covering the assembly can be made thin, and the usage of the material such as resin can be reduced. The reduction in the usage of the material such as resin is an effect due to small roughness of the surface profile of the outer circumference of the assembly that can be filled with a small amount of resin. The reduction in thickness of the covering layer is an effect due to the substantially circular outer circumference of the assembly composed of plural twisted aluminum alloy strands which can minimize the thickness of the covering layer.

The aluminum alloy electrical wire subjected to the compression process typically has a space factor of not less than 90%. Herein, the space factor refers to a ratio of the total area of the cross sectional areas of aluminum alloy strands constituting an aluminum alloy electric wire to the area of the circumscribed circle of the plural aluminum alloy strands located in the outer periphery. The space factor of a 1-6 type electrical wire subjected to the compression process of (14) is calculated as 95% where the area of the circle circumscribing the six aluminum alloy strands of the second strand section is 100 and the total of the cross-sectional areas of the one aluminum alloy strand of the first strand section and the six aluminum alloy strands of the second strand section is 95, for example.

An aluminum alloy electrical wire not subjected to the compression process typically has a space factor of not less than 72%. In the aluminum alloy electrical wire not subjected to the compression process, each aluminum alloy strand has a circular cross section, and gaps are more likely to be formed between adjacent aluminum alloy strands. The aluminum alloy electrical wire not subjected to the compression process has a smaller space factor than an aluminum alloy electrical wire subjected to the compression process.

The electrical wire is a covered wire in which a stranded wire as a bare wire is covered with any insulating resin layer. A plurality of such electrical wires are bound into one bundle and assembled to a sheath, thus forming a wire harness. The electrical wire or cable according to the embodiment only needs to include: a conductor (that is, a stranded wire) including strands consisting of the above-described aluminum alloy; and a cover layer provided on the outer circumference of the conductor. The other specific configuration and shape and the manufacturing method thereof are not limited.

The shape and the like of the aluminum alloy strands constituting the conductor are not particularly limited. However, when the strands are round wires and are used in electrical wires for automobiles, for example, the diameter (that is, the final diameter) of the strands is preferably about 0.07 to 1.5 mm and more preferably about 0.14 to 0.5 mm.

The resin used in the cover layer can be any publicly known insulating resin such as vinyl chloride and olefin resin including cross-linked polyethylene and polypropylene. The thickness of the cover layer is properly determined. The electrical wire or cable according to the embodiment can be used in various applications such as electric or electronic components, mechanical components, vehicle components, and building materials. In these applications, the electrical wire or cable of the embodiment is preferably used as an electrical wire or cable for vehicles.

The aluminum alloy strands serving as the conductor of the electrical wire or cable of the embodiment are manufactured by preparing a wire rod by an ordinary manufacturing method and drawing the prepared wire rod. For wire drawing, heat treatment (annealing) may be properly performed. However, it is preferable to perform heat treatment for an aluminum alloy strand already drawn to the final diameter. When the wire rod is drawn without being subjected to heat treatment before or during the process of wire drawing, the drawn wire rod is subject to less work hardening. Moreover, execution of annealing after wire drawing improves the characteristics such as the conductivity and elongation.

The method of manufacturing an aluminum alloy strand is preferably one of first and second methods below. The first method includes: (1) a step of forming a wire rod using the above-described aluminum alloy (a rolling step); (2) a step of drawing the formed wire rod to a final diameter (an area-reduction step); (3) a step of continuous or batch annealing wire materials subjected to wire drawing; and (4) a step of twisting the annealed wire materials to form a stranded wire (a twisting step).

The second method includes: (11) a step of forming a wire rod using the above-described aluminum alloy (a rolling step); (12) a step of drawing the formed wire rod to a final diameter (an area-reduction step): (13) a step of twisting the drawn wire materials to form a stranded wire (a twisting step); (14) a step of compressing the stranded wire on the outer circumference to reduce the diameter of the stranded wire (a compression step); and (15) a step of continuous or batch annealing the compressed stranded wire. Herein, the wire-drawing steps of (2) and (12) refer to area-reduction processes and do not include heat treatment. The wire-drawing steps of (2) and (12) are not accompanied with heat treatment.

In the first and second methods, the aforementioned aluminum alloy provided for the rolling steps of (1) and (11) is manufactured by casting. The casting step uses a method of producing a stick through a continuous casting method using a belt wheel-type casting machine or a method of performing extrusion for a bullet as a mass of aluminum to obtain an extruded material.

The compression step (14) is a step to compress the outer circumference of the stranded wire composed of plural aluminum alloy strands having circular cross sections and to deform the cross sections of the aluminum alloy strands so that gaps between adjacent aluminum alloy strands are reduced.

When the compression step (14) is performed in the second method, the annealing step (15), which is the same as the annealing step (3) in the first method, is performed after the compression step. In the second method, the aluminum alloy wire material is subject to large working strain in the compression step (14). To remove the working strain, the annealing step (15) is performed after the compression step (14).

According to the first method, strands are manufactured through the process flow of the rolling, wire-drawing (area-reduction), annealing, and twisting steps after casting. According to the second method, strands are manufactured through the process flow of the rolling, wire-drawing (area-reduction), twisting, compression, and annealing steps after casting. Compared with a conventional manufacturing method composed of casting, rolling, wire-drawing, heat treatment, wire-drawing, and heat treatment steps, the first and second methods perform wire drawing and heat treatment only once and have significantly high effects on time and cost.

Each step is performed by a publicly-known method, and the first and second methods may include another process to manufacture strands, such as a facing process, for example, in addition to (1) to (4) described above if necessary. The wire rod (1) can be processed by continuous casting and rolling, extrusion, or the like. The rolling may be either hot rolling or cold rolling. The wire-drawing of (2) and (12) is performed using a dry or wet wire drawing machine, and the conditions thereof are not particularly limited.

The aforementioned aluminum alloy is excellent in drawing workability. A wire rod having a diameter of 9.5 mm can be drawn to a finished diameter of about 0.3 mm without heat treatment, for example.

In the annealing steps (3) and (15) the continuous annealing can be performed using a continuous annealing furnace. For example, an aluminum wire is conveyed at a predetermined speed through a heating furnace so as to be heated in a predetermined zone for annealing. The method of continuous annealing includes continuous annealing through application of electrical current or continuous annealing through induction. The heating means includes a high-frequency heating furnace or the like, for example. The annealing process can preferably employ batch annealing using an atmosphere furnace or the like. The conveying speed, annealing time, annealing temperature, and the like are not particularly limited, and the conditions for cooling after annealing are also not particularly limited. In the annealing steps (3) and (15), the method of annealing is preferably continuous annealing because the annealing can be performed on production line.

As described above, in the embodiment, the aluminum alloy having the aforementioned composition is used as the raw material of aluminum alloy strands. This allows wire drawing to be performed before heat treatment and allows annealing after wire drawing to be performed. Generally, heat treatment performed after wire drawing can improve the conductivity and elongation properties of the aluminum alloy strands but softens the aluminum alloy once hardened by working. The strength (tensile strength) thereof is therefore reduced. The aluminum alloy as a material of the aluminum alloy strand according to the embodiment has such a composition that satisfies various required characteristics including the strength even if the strength is reduced. According to the aluminum alloy strand using the above-described aluminum alloy, it is possible to provide an aluminum alloy strand which has lightweight properties as one of the features of aluminum, has a good conductivity, and includes a high elongation percentage and sufficient tensile strength.

As for the properties of the aluminum alloy strand according to the embodiment, the tensile strength thereof is not less than 120 MPa, and the conductivity thereof is not less than 58% IACS. The tensile strength of the aluminum alloy strand according to the embodiment is preferably 120 to 150 MPa and more preferably 120 to 140 MPa. The conductivity of the aluminum alloy strand according to the embodiment is preferably 58 to 64% IACS and is not higher than 64% IACS, which is the conductivity of pure aluminum. The aluminum alloy strand has an elongation percentage of not less than 10%, preferably 10 to 30%, and more preferably 15 to 20%. Moreover, as for the drawing workability, the disconnection rate is preferably not less than 25000 m/disconnection and more preferably not less than 33000 m/disconnection. The disconnection rate refers to length of aluminum alloy strand per one disconnection during the process of manufacturing the aluminum alloy strand from an aluminum alloy wire rod through wire drawing and the like.

### EXAMPLES

Hereinafter, the present invention is described in more detail with examples but is not limited to these examples.

### Examples 1 to 7 and Comparative Examples 1 and 2

Grade-1 aluminum ingots (JIS J 2102) were added with predetermined amounts of Ti, Fe, Zr, Mg, and Cu or Si, thus preparing aluminum alloys having component compositions illustrated in Table 1. These aluminum alloys were melted by an ordinary method and were processed into wire rods having a diameter of 9.5 mm by continuous casting and rolling.

Next, the wire rods were subjected, to a peeling process to remove the surfaces until damage in the surfaces disappeared and were then drawn using a continuous drawing machine, thus preparing wire materials (thin wires) with diameters of 0.32 mm. The wire materials were subjected to continuous annealing, manufacturing aluminum alloy strands.

### (Evaluation)

The obtained aluminum alloy strands with diameters of 0.32 mm were evaluated in terms of the following properties in accordance with JIS C3002. The conductivity was calculated by using four-terminal sensing to measure the specific resistance in a constant-temperature bath maintained at 20° C. (±05° C.) The distance between terminals was set to 1000 mm. The tensile strength was measured at a tensile speed of 50 mm/min.

The obtained results are shown in Table 1.

TABLE 1

| | | | | | | | | | Tensile |
|---|---|---|---|---|---|---|---|---|---|
| | Alloy | Alloy Component Composition (mass %) | | | | | | Conductivity | Strength |
| Sample No. | No. | Ti | Zr | Fe | Cu | Si | Mg | (% IACS) | (MPa) |
| Example 1 | 1 | 0.001 | 0.008 | 0.675 | — | 0.02 | 0.35 | 58.1 | 128 |
| Example 2 | 2 | 0.005 | 0.008 | 0.675 | — | 0.02 | 0.35 | 58.0 | 132 |
| Example 3 | 3 | 0.009 | 0.008 | 0.675 | — | 0.02 | 0.32 | 58.0 | 134 |
| Example 4 | 4 | 0.001 | 0.005 | 0.600 | — | 0.02 | 0.32 | 58.6 | 123 |
| Example 5 | 5 | 0.005 | 0.005 | 0.600 | — | 0.02 | 0.32 | 58.3 | 127 |
| Example 6 | 6 | 0.009 | 0.005 | 0.600 | — | 0.02 | 0.32 | 58.1 | 131 |
| Example 7 | 7 | 0.009 | 0.008 | 0.675 | 0.05 | — | 0.34 | 58.0 | 135 |
| Comparative | 8 | 0.011 | 0.005 | 0.600 | — | 0.02 | 0.32 | 57.8 | 133 |
| Example 1 | | | | | | | | | |
| Comparative | 9 | 0.012 | 0.005 | 0.600 | — | 0.02 | 0.32 | 57.7 | 134 |
| Example 2 | | | | | | | | | |

### Example 8

An aluminum alloy strand was manufactured in a similar manner to Example 2 except that the peeling process was not performed. The aluminum alloy strands of Examples 2 and 8 both consist of alloy No. 2 containing 0.005 mass % of Ti. The difference between the aluminum alloy strands of Examples 2 and 8 was whether the peeling process was executed or not.

### (Evaluation)

The aluminum alloy strands of Examples 2 and 8 were measured in terms of the disconnection rate. The disconnection rate refers to length of an aluminum alloy strand per one disconnection during the process of manufacturing the aluminum alloy strand from an aluminum alloy wire rod through wire drawing and the like. When the aluminum alloy rod is disconnected twice during the process of manufacturing a 50000 m aluminum alloy strand, for example, the disconnection rate is 50000 m/twice, that is, 25000 m per disconnection. Larger disconnection rates mean lower frequency of disconnections during manufacture.

The obtained results are shown in Table 2.

TABLE 2

| | Alloy | Peeling | Disconnection Rate |
|---|---|---|---|
| Sample No. | No. | Process | (m/Disconnection) |
| Example 2 | 2 | Executed | 25000 |
| Example 8 | 2 | Not | 33000 |
| | | Executed | |

It was therefore confirmed that the aluminum alloy strands of Examples were excellent in conductivity and tensile strength and were preferably used as conductors of electrical wires or cables for automobiles.

On the other hand, the aluminum alloy strands of Comparative Examples did not provide desired conductivity.

The electrical wire or cable of the present invention includes an aluminum alloy strand which is lightweight and is excellent in conductivity and tensile strength. The electrical wire or cable of the present invention is therefore preferably used in wire harnesses for automobiles in particular.

The aluminum alloy according to the present invention has a composition that provides conductivity and tensile strength necessary as the conductor of an electrical wire or cable while providing excellent drawing workability and allowing a wire rod to be drawn to a strand's final diameter without annealing (heat treatment) in the middle of the process. By using the aluminum alloy of the present invention, the aluminum alloy strand can be manufactured by continuous annealing or batch annealing subsequent to wire drawing without performing heat. treatment before or in the middle of the wire drawing. This can reduce the cost and increase the productivity.

The electrical wire or cable according to the present invention includes an aluminum alloy strand excellent in conductivity, tensile strength, and elongation properties while being lightweight.

In the electrical wire or cable according to the present invention, the aluminum alloy has a Ti content of not less than 0.001 mass % and less than 0.009 mass %. Accordingly, the aluminum alloy strand has a conductivity of not less than 58% IACS and a tensile strength of not less than 120 MPa.

In the electrical wire or cable according to the present invention, the aluminum alloy has a Ti content of not less than 0.001 mass % and less than 0.009 mass % and is excellent in tensile strength and workability. Accordingly, the aluminum alloy strand is less likely to be disconnected during manufacture irrespectively of execution of a so-called peeling process to remove the surface layer of the aluminum alloy wire material before wire drawing.

The wire harness according to the present invention is lightweight and thin and is therefore suitable for automobiles.

With the method of manufacturing an aluminum alloy strand according to the present invention, the aluminum alloy strand of the electrical wire or cable according to the present invention can be manufactured efficiently.

What is claimed is:

1. A method of manufacturing an aluminum alloy strand from an aluminum alloy containing:
not less than 0.001 mass % and less than 0.009 mass % of Ti,
0.4 to 0.9 mass % of Fe,
0.005 to 0.008 mass % of Zr,
0 to 0.02 mass % of Si, and
at least one of 0 to 0.05 mass % of Cu and 0. 04 to 0.45 mass % of Mg with a residue being composed of aluminum and inevitable impurities, the method comprising the steps of
(1) a step of forming a wire rod using the aluminum alloy;
(2) a step of drawing the wire rod to a desired final diameter without performing heat treatment; and
(3) a step of continuous annealing or batch annealing the drawn wire material.

2. The method of manufacturing an aluminum alloy strand according to claim 1, wherein the disconnection rate during the process of manufacturing the aluminum alloy strand starting with an aluminum alloy rod through a drawing step and the like is 25000 m per disconnection or more.
